(19) United States
(12) Patent Application Publication
(10) Pub. No.: US 2011/0064548 A1
(43) Pub. Date: Mar. 17, 2011

(54) APPARATUS AND METHODS FOR MEDICAL DEVICE TRANSFER

(75) Inventors: Darryl T. Wrolson, Waconia, MN (US); Tom H. Borlaug, Prior Lake, MN (US); Steven P. Plager, Eden Prairie, MN (US); David D. Scott, Minneapolis, MN (US)

(73) Assignee: ACIST MEDICAL SYSTEMS, INC., Eden Prairie, MN (US)

(21) Appl. No.: 12/561,407

(22) Filed: Sep. 17, 2009

(51) Int. Cl. B65G 67/02

(52) U.S. Cl. 414/349; 414/800; 414/809; 414/787

(57) ABSTRACT

A post extending from a medical device facilitates transfer of the device between first and second support structures. Each of the first and second structures includes a mounting receptacle, configured to receive the post, fitting either tightly or loosely thereabout, depending on a position of the post along an axis of the receptacle. When the first receptacle holds the post and is moved in a first direction, the post may be moved into the second receptacle, which is then moved in a second direction, to tighten the second receptacle and loosen the first receptacle about the post. When the second receptacle holds the post, the first receptacle may be moved in the first direction, until the post enters the first receptacle, and, then, the second receptacle may be moved in a direction opposite to the second direction, to loosen the second receptacle and tighten the first receptacle about the post.

### TECHNICAL FIELD

The present disclosure pertains to methods and accessories for medical devices and more particularly to those that facilitate the transfer of medical devices.

### BACKGROUND

Many types of external medical devices, for example, those useful for diagnostic imaging and/or therapeutic administration, often need to be transferred between at least two mounting or support structures. A first of the support structures may be one that is useful for transporting such a medical device from one location to another, for example, a cart for wheeling the device about a hospital or clinic, and a second of the support structures may be one that is permanently located in proximity to a patient bed or table, for example, in a hospital room, operating room or diagnostic suite. Often times the external medical devices are relatively heavy (and may be bulky), so that an operator who handles the transfer of these devices, from one support structure to another, will need to demonstrate a certain amount of strength and coordination, not only to safely handle the weight of the device but to also ensure that the device is safely released from the one structure and safely mounted to the other structure. Thus, there is a need for apparatus and methods to facilitate medical device transfer.

### BRIEF DESCRIPTION OF THE DRAWINGS

The following drawings are illustrative of particular methods and embodiments of the present disclosure and, therefore, do not limit the scope of the invention. The drawings are not to scale (unless so stated) and are intended for use in conjunction with the explanations in the following detailed description. Methods and embodiments will hereinafter be described in conjunction with the appended drawings, wherein like numerals denote like elements.

FIG. 1 is a perspective view of a medical system in conjunction with first and second support structures, each of which may employ embodiments of the present disclosure.

FIGS. 2-4 are perspective views of various elements that may be included in a device transfer package or system, according to some embodiments.

FIGS. 5A-E are schematics illustrating some methods of the present disclosure.

FIG. 6 is a perspective view of a medical device mounted to a support structure, according to some embodiments.

### DETAILED DESCRIPTION

The following detailed description is exemplary in nature and is not intended to limit the scope, applicability, or configuration of the invention in any way. Rather, the following description provides practical illustrations for implementing exemplary methods and embodiments. Those skilled in the art will recognize that many of the examples provided have suitable alternatives that can be utilized.

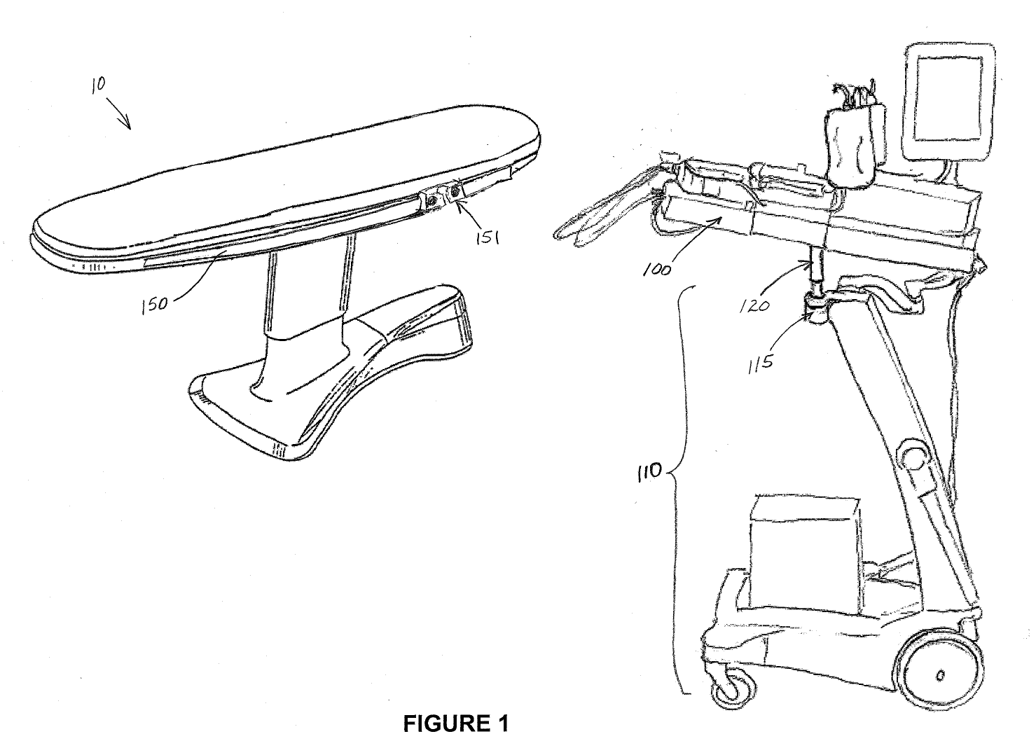

FIG. 1 is a perspective view of a medical system, which includes a medical device 100. An elongate post 120 is shown extending therefrom in order to mount device 100 to a first support structure 110. FIG. 1 illustrates first support structure 110 as a cart, which has been rolled into proximity with a second support structure 150. According to the illustrated embodiment, second support structure 150 is formed by a rail of a patient table 10, on which a patient may be positioned for diagnostic imaging, for example, angiography that is facilitated by contrast injections administered from medical device 100. It should be noted that, although medical device 100 is illustrated as an angiographic contrast injector, any other type of medical device, for example, useful for other types of imaging and/or the administration of therapy, may be included in medical systems of the present disclosure and/or be configured to benefit from device transfer systems and/or methods of the present disclosure.

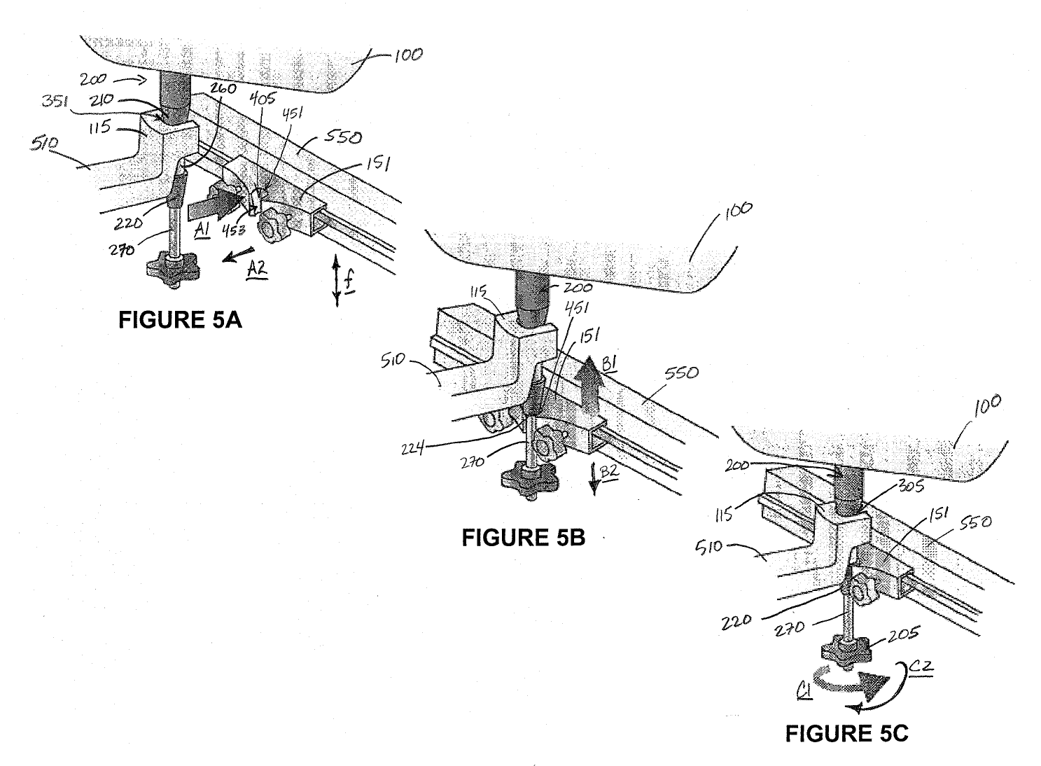

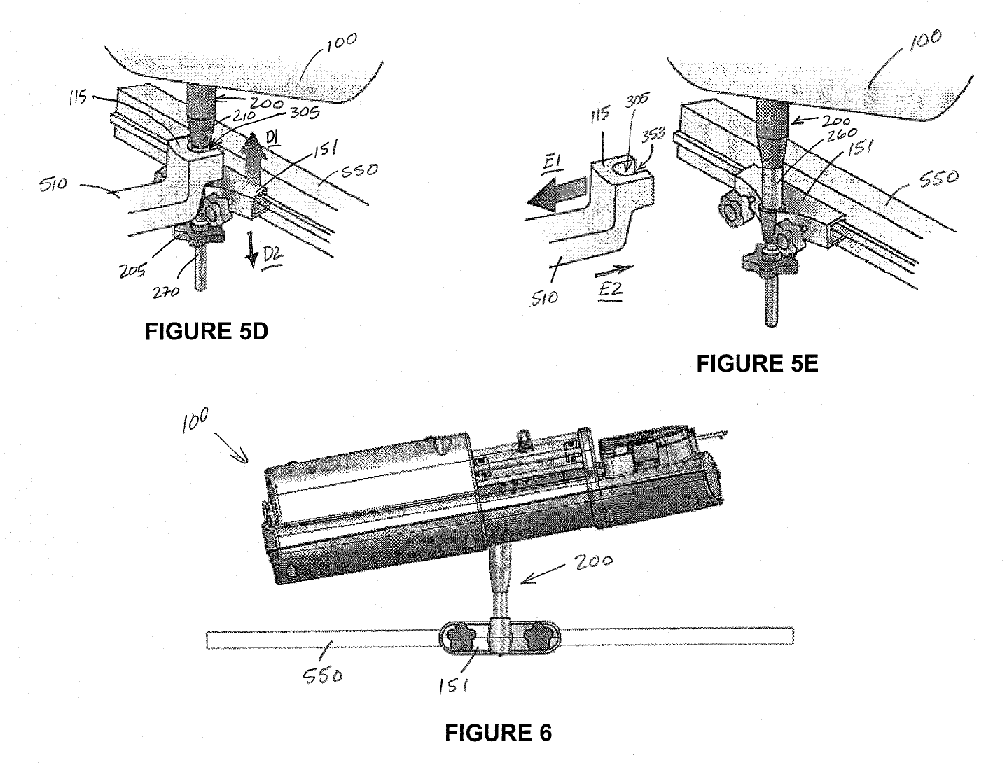

FIG. 1 further illustrates a mounting fixture 115 of cart 110, in which elongate post 120 is inserted for the mounting of device 100, a mounting fixture 151 of rail 150, to which medical device 100 may also be mounted, for example, as illustrated in FIGS. 5E and 6. According to some embodiments, post 120 is integral with medical device 100 and is configured to facilitate transfer of device 100 between two support structures, for example, from cart 110 to rail 150 and/or from rail 150 to cart 110. Alternately, a separate elongate post is configured to facilitate the transfer, and post 120 is either configured to be interchangeable with the separate post, or adapted to receive the separate post.

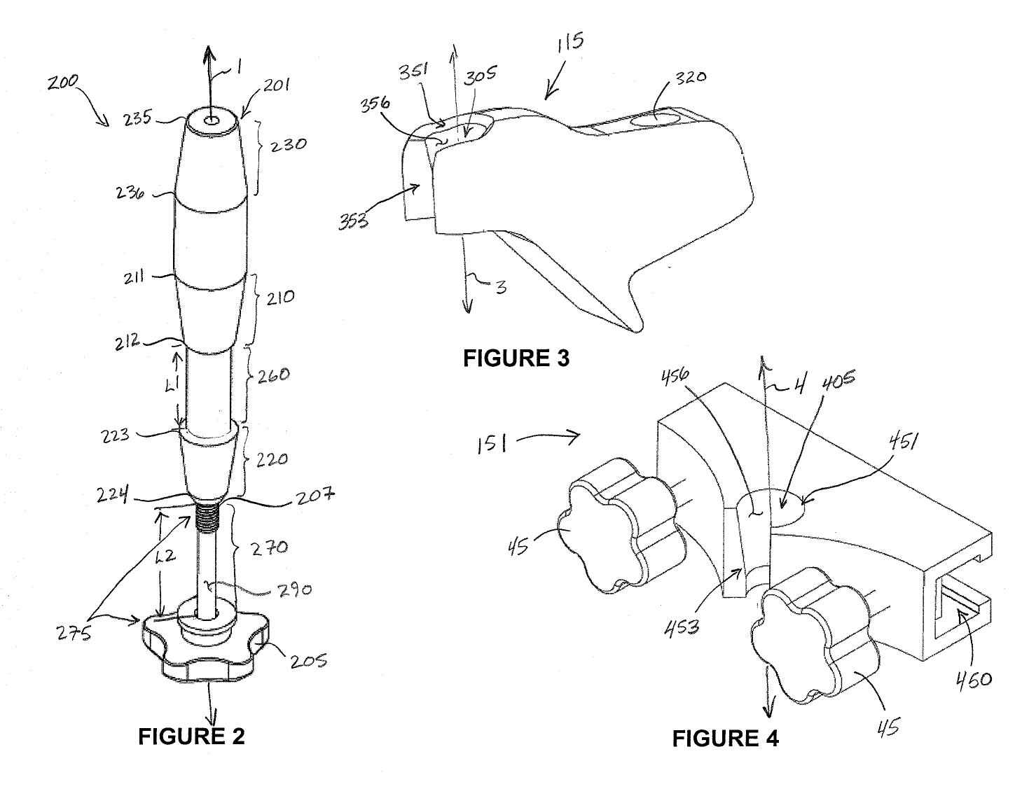

FIG. 2 is a perspective view of an elongate transfer post 200, according to some embodiments. FIG. 2 illustrates post 200 being substantially aligned along a longitudinal axis 1 and including a first terminal end 201, first and second tapered segments 210, 220 and a transfer segment 260, which extends between tapered segments 210, 220. According to some embodiments, tapered segments 210 and 220 are formed by frusto-conical portions of post 200, each of which are substantially aligned along axis 1. FIG. 2 further illustrates an optional second transfer segment 270 that extends from a smaller diameter 224 of second tapered segment 220. First terminal end 201 is shown coinciding with a smaller diameter 235 of an optional third tapered segment 230, which tapers from diameter 235 to a larger diameter 236 and is configured to be received within a mounting bore (not shown) of medical device 100 (FIGS. 1 and 6). The mounting bore may be located within a terminal end of post 120, such that post 200, when mounted therein, may extend into mounting fixture 115 of cart 110; or, the mounting bore may be located in a lower portion or sidewall of medical device 100 and post 120 may be removable therefrom, so that post 120 can be exchanged for transfer post 200. According to alternate embodiments, as mentioned above, post 120 of FIG. 1 may be configured like transfer post 200, for example, to include first and second tapered segments 210, 220 and at least transfer segment 260 (and optionally, transfer segment 270).

With further reference to FIG. 2, first tapered segment 210 is shown tapering from a larger diameter 211 to a smaller diameter 212, which is adjacent transfer segment 260, and second tapered segment 220 is shown tapering from a larger diameter 223 to smaller diameter 224, which is adjacent transfer segment 270. According to the illustrated embodiment, each of tapered segments 210, 220 is adapted to fit within a mounting receptacle of the corresponding mounting fixture 115, 151, for example, like those shown in FIGS. 3 and 4.

FIGS. 3 and 4 are perspective views of mounting fixtures 115 and 151, respectively, according to some embodiments. FIG. 3 illustrates a mounting receptacle 305 of mounting fixture 115 that extends along a longitudinal axis 3 and includes a radial opening 351 and an axial opening 353; and FIG. 4 illustrates a mounting receptacle 405 of mounting fixture 151 that extends along a longitudinal axis 4 and includes a radial opening 451 and an axial opening 453. According to some preferred embodiments, first tapered segment 210 of post 200 is configured to be received in mounting receptacle 305, for example, via an axial movement of diameter 212 through radial opening 351; and second tapered segment 220 is configured to be received in mounting receptacle 405, for example, via an axial movement of diameter 224 through radial opening 451. The reception and fit of tapered segments 210 and 220 in the respective mounting receptacles 305 and 405 will be described in greater detail below.

According to some embodiments, each of mounting receptacles 305 and 405 have a tapered inner surface 356 and 456, respectively, which taper from a larger diameter, at the respective opening 351, 451, down to a smaller diameter, within the respective receptacle 305, 405. Inner surfaces 356, 456 may be formed, according to some embodiments, from a relatively hard material, for example, either from a metal, preferably aluminum, or a hard plastic. With reference back to FIG. 2, each of tapered segments 210, 220, according to some embodiments, may likewise be formed from a sufficiently hard material, such as a metal or a hard plastic, to allow for sliding engagement with the respective inner surface 356, 456; however, according to some preferred embodiments, the material forming tapered segments 210, 220 is not as hard as the material forming inner surfaces 356, 456, for example, to avoid galling. According to some exemplary embodiments, each of segments 210, 220, 230 are formed from a relatively hard plastic, for example, a polyacetal resin such as Delrin® acetal resin (available from DuPont™), and are mounted onto a relatively rigid core 290 of post 200, which may be formed from stainless steel.

Each of mounting fixtures 115, 151 and post 200 may be included in a package or system that is useful for transferring medical devices, such as medical device 100, between support structures. FIG. 3 illustrates mounting fixture 115 including a bore 320, which may facilitate removable attachment to cart 110, according to some embodiments, however, according to some preferred embodiments, mounting fixture 115 is an integral component of cart 110. FIG. 4 illustrates mounting fixture 151 including a pair of fasteners 45 and a groove 450, which is configured to fit about a portion of a support structure, for example, rail 150 as illustrated in FIGS. 1, 5A-E and 6; fasteners 45 may be alternately tightened, to secure mounting fixture 151 at a fixed location on the portion of the support structure, and loosened, to adjust a location of mounting fixture 151 along the portion of the support structure, for example, rail 150.

FIG. 5A is first schematic of a series of schematics that illustrate some methods of the present disclosure. FIG. 5A shows transfer post 200 attached to medical device 100, such that post 200 extends downward from a lower portion of device 100. According to the illustrated embodiment, transfer post 200 is rigidly secured to medical device 100 so that mounting fixture 115, for example, of first support structure 510, can hold and/or support device 100. The manner in which transfer post 200 and medical device 100 become supported by mounting fixture 115 (as shown in FIG. 5A) may be described with reference to FIGS. 2 and 3. For example, transfer segment 260 of post 200 has a length L1 and a diameter that facilitate a movement of transfer segment 260 through axial opening 353 of receptacle 350. According to some embodiments, length L1 of transfer segment 260 is longer than a length of axial opening 353, and/or the diameter of transfer segment 260 is smaller than a width of axial opening 353. Axial opening 353 may be tapered to facilitate a guiding of transfer segment 260 therethrough and into receptacle 305, according to some embodiments. Once transfer segment has been moved into receptacle 305, smaller diameter 212 of first tapered segment 210 becomes substantially aligned over radial opening 351 of receptacle 305. Smaller diameter 212 of first tapered segment 210 of post 200 may then be moved axially into mounting receptacle 305, through radial opening 351, such that an outer surface of first tapered segment 210 wedges against inner surface 356 of mounting receptacle 305 and is held therein by gravity.

FIG. 5A illustrates an arrow A1 that designates a direction in which post 200 is moved, via mounting fixture 115 of first support structure 510 (e.g. cart 110 of FIG. 1), in order to transfer device 100 from first support structure 510 to a second support structure 550 (e.g. rail 150 of FIG. 1), to which mounting fixture 151 is attached. With reference to FIG. 5A, in conjunction with FIG. 5B, it may be appreciated that second transfer segment 270 is aligned by mounting fixture 115 for entry, per arrow A1, into axial opening 453 of mounting receptacle 405. It should be noted that, according to some alternate embodiments, transfer post 200 need not include second transfer segment 270 and may terminate in proximity to smaller diameter 224 of second tapered segment 220, in which case, mounting receptacle 405 of mounting fixture 151 need not include axial opening 453, according to some embodiments. However, some preferred embodiments include second transfer segment 270, for example, to facilitate alignment of second tapered segment 220 over radial opening 451 of mounting receptacle 405, as illustrated in FIG. 5B. With further reference to FIG. 5A, a double-headed arrow “f” indicates a direction, which is approximately orthogonal to arrow A1 and in which one or both of mounting fixtures 115, 151 may have initially been moved in order to offset radial openings 351 and 451 from one another, as illustrated in FIG. 5A.

FIG. 5B further illustrates an arrow B1 that designates a direction in which mounting fixture 151 may be moved, the direction of arrow B1 being approximately orthogonal to that designated by arrow A1 of FIG. 5A. According to the illustrated method, mounting fixture 115 and post 200 remain stationary while mounting fixture 151 is moved, per arrow B1, in order to tighten a fit of mounting receptacle 405 about tapered segment 220 of post 200. With reference back to FIGS. 2 and 4, it may be appreciated that second tapered segment 220 of post 200 is configured such that an outer surface thereof wedges against inner surface 456 of mounting receptacle 405, when radial opening 451 is moved, axially, past smaller diameter 224 of segment 220, per arrow B1 (or vice versa, wherein smaller diameter 224 is moved past radial opening 451 and into receptacle 405). Alternately, FIG. 5B also shows an arrow B2 that designates a direction in which mounting fixture 115 may be moved (along with post 200 and device 100), relative to mounting fixture 151, while mounting fixture 151 and second support structure 550 remain relatively stationary.

FIG. 5C illustrates the tightened fit of mounting receptacle 405 about segment 220 of post 200, which may be sufficient, along with gravity, to support medical device 100. FIG. 5C further illustrates an arrow C1, which designates a direction in which an optional fastening member 205 may be turned to further secure post 200 within receptacle 405. With reference back to FIG. 2, fastening member 205 is shown as a part of an optional fastening mechanism 275, which is formed on second transfer segment 270 and further includes a set of mating threads 207. According to the illustrated embodiment, fastening member 205 is a nut-type fastener that engages with threads 207, as shown in FIG. 5D, in order to prevent axial movement of second tapered segment 220 of post 200 out from receptacle 405, through axial opening 451. With further reference to FIG. 2, it may be appreciated that a length L2 of second transfer segment 270, as well as a diameter thereof, allow second transfer segment 270 to be passed through axial opening 453 of receptacle 405, as illustrated in FIG. 5B.

FIG. 5D illustrates an arrow D1 that designates a direction in which mounting fixture 151 has been moved, from the position illustrated in FIG. 5C, wherein the movement is parallel with the prior movement, per arrow B1. According to the illustrated method, the movement of mounting fixture 151, per arrow D1, also moves post 200 and medical device 100 with respect to mounting fixture 115 of first support structure 510, thereby serving to loosen the fit of mounting receptacle 305 about first tapered segment 210 of post 200 and to position transfer segment 260 of post 200 for passing through axial opening 353 of mounting receptacle 305, when first support structure 510 is separated from post 200 and medical device 100, as shown in FIG. 5E. It should be noted that, according to alternate embodiments, in which post 200 does not include fastening member 205, or according to alternate methods, wherein member 205 is not tightened, the separate movements, per arrows B1 and D1, may be combined into a single movement to, first, tighten the fit of receptacle 405 about second tapered segment 220 of post 200, and, then, loosen the fit of receptacle 305 about first tapered segment 210 of post 200.

FIG. 5E illustrates an arrow E1, which designates a direction, opposite to that designated by arrow A1 of FIG. 5A, in which first support structure 510 is separated from post 200 and medical device 100. FIGS. 5E and 6 show post 200 held in mounting fixture 151 so that second support structure 550 supports medical device 100, for example, while device 100 operates to facilitate diagnostic imaging and/or the administration of therapy for a patient, who may also be supported by second support structure 550.

FIGS. 5A-E further illustrate, in reverse sequence from FIG. 5E to FIG. 5A, methods of the present disclosure for transferring medical device 100 from second support structure 550 to first support structure 510, for example, in order to transport medical device 100 to another location. FIG. 5E illustrates an arrow E2, which designates a direction in which first support structure 510 and mounting fixture 115 may be moved back into proximity with medical device 100, post 200 and mounting fixture 151. FIG. 5D illustrates mounting fixture 115 having been moved, per arrow E2, such that transfer segment 260 of post 200 has entered mounting receptacle 305 via axial opening 353. FIG. 5D further illustrates an arrow D2, which designates a direction in which mounting fixture 151 may be moved in order to tighten a fit of mounting receptacle 305 of mounting fixture 115 about first tapered segment 210 of post 200, while post 200 is still secured, via fastening member 205, within mounting receptacle 405 of mounting fixture 151. The tightened fit of mounting receptacle 305 about post 200 is illustrated in FIG. 5C. FIG. 5C further illustrates fastening member 205 having been turned, per arrow C2, in order to release the securing of post 200 within receptacle 405 of mounting fixture 151; and FIG. 5B illustrates an arrow B2, which designates a direction in which mounting fixture 151 has been moved to loosen the fit of receptacle 405 about second tapered segment 220 of post 200. Thus, in summary, movement of mounting fixture 151 in the direction designated by arrows D2 and B2 serves to, first, tighten the fit of receptacle 305 about first tapered segment 210 of post 200 and, then, loosen the fit of receptacle 405 about second tapered segment 220 of post 200. As described above, with respect to arrows B1 and D1, movement per arrows B2 and D2 may likewise be combined into a single movement, if fastening member 205 is not present or had not previously been tightened. Finally, with reference to FIG. 5A, an arrow A2 designates a direction in which mounting fixture 115 has been moved in order to separate medical device 100, and attached post 200, from second support structure 550. According to the illustrated embodiment, wherein post 200 includes second transfer segment 270, it should be noted that movement, per arrow B2, to the position illustrated in FIG. 5B, causes transfer segment 270 to be aligned for passage through axial opening 453 of mounting receptacle 405.

It should be noted that, although it may be inferred from the present disclosure that support structures 110/510 and 150/550 are moved in order to move the respective mounting fixtures 151 and 115, embodiments of the present invention are not so limited. For example, any or all of support structures 110/510 and 150/550 may be adapted to allow for independent movement of the corresponding mounting receptacles 305, 405, for example, according to any or all of the associated arrows A1/2, B1/2, D1/2, E1/2 of FIGS. 5A-E; such independent movement could be facilitated, for example, by articulating feedback-controlled arms, which are coupled to the support structures and in which the mounting receptacles are formed. Furthermore, although the movement associated with arrows A1/2, E1/2 and arrows B1/2, D1/2 is preferably horizontal and vertical, respectively, it is contemplated that, according to some alternate methods, the movements may be skewed from the horizontal and vertical.

In the foregoing detailed description, the invention has been described with reference to specific embodiments. However, it may be appreciated that various modifications and changes can be made without departing from the scope of the invention as set forth in the appended claims. For example, the particular configurations of the mounting fixtures described herein, for example, related to how the mounting fixtures are attached to the corresponding support structures, are exemplary in nature and other configurations may be suitable for embodiments of the present invention.

We claim:

1. A method for transferring a medical device between a first support structure and a second support structure, the method comprising:
positioning a mounting fixture of the first support structure in proximity to a mounting fixture of the second support structure;
moving a post, which is attached to the medical device, in a first direction, into a receptacle of the mounting fixture of the second support structure, the post being held in the receptacle of the mounting fixture of the first support structure when the post is moved into the receptacle of the mounting fixture of the second support structure; and
moving the mounting fixture of the second support structure in a second direction, after the post is moved into the receptacle of the mounting fixture thereof, the second direction being approximately orthogonal to the first direction;
wherein moving the mounting fixture of the second support structure in the second direction tightens a fit of the receptacle thereof about the post, and loosens a fit of the receptacle of the mounting fixture of the first support structure about the post, so that the first support structure can be separated from the post and the medical device attached thereto.

2. The method of claim 1, further comprising securing the post within the receptacle of the mounting fixture of the second support structure to prevent movement of the post, with respect to the mounting fixture of the second support structure, in the second direction.

3. The method of claim 2, wherein securing the post within the receptacle of the mounting fixture of the second support structure comprises tightening a nut on the post against the mounting fixture of the second support structure.

4. The method of claim 2, wherein moving the mounting fixture of the second support structure in the second direction comprises:
moving the mounting fixture of the second support structure in the second direction, over a first distance, to tighten the fit of the receptacle thereof about the post, prior to securing the post within the receptacle; and
moving the mounting fixture of the second support structure further in the second direction, over a second distance, to loosen the fit of the receptacle of the mounting fixture of the first support structure about the post.

5. The method of claim 1, wherein the first support structure comprises a cart and positioning the mounting fixtures of the first and second support structures comprises rolling the cart into proximity with the second support structure.

6. The method of claim 5, wherein the second support structure comprises a rail of a patient table.

7. The method of claim 1, wherein positioning the mounting fixtures of the first and second support structures comprises moving the mounting fixture of one or both of the first and second support structures in a direction approximately parallel to the second direction in order that an opening into the receptacle of the mounting fixture of the first support structure is located at an elevation that is offset from an elevation of an opening into the receptacle of the mounting fixture of the second support structure.

8. The method of claim 1, wherein the first direction is horizontal.

9. The method of claim 1, wherein the second direction is vertical.

10. The method of claim 1, further comprising separating the first support structure from the post, and the medical device attached thereto, by moving the mounting fixture of the first support structure in a direction opposite to the first direction, such that the post exits the receptacle of the mounting fixture of the first support structure while remaining within the receptacle of the mounting fixture of the second structure.

11. The method of claim 10, further comprising:
moving the mounting fixture of the first support structure back in the first direction such that the post enters the receptacle thereof; and
moving the mounting fixture of the second support structure in a third direction, after the post enters the receptacle of the mounting fixture of the first support structure, the third direction being opposite to the second direction;
wherein moving the mounting fixture of the second support structure in the third direction loosens the fit of the receptacle thereof about the post, and tightens the fit of the receptacle of the mounting fixture of the first support structure about the post, so that the mounting fixture of the first support structure can separate the post, and the medical device attached thereto, from the second support structure.

12. The method of claim 11, further comprising:
securing the post within the receptacle of the mounting fixture of the second support structure, prior separating the first support structure from the post, and the medical device attached thereto, to prevent movement of the post, with respect to the mounting fixture of the second support structure, in the second direction; and
releasing the securing of the post within the receptacle of mounting fixture of the second support structure, prior to moving the mounting fixture of the first support structure in the direction opposite the first direction.

13. The method of claim 12, wherein securing the post within the receptacle of the mounting fixture of the second support structure comprises tightening a nut on the post against the mounting fixture of the second support structure.

14. The method of claim 12, wherein moving the mounting fixture of the second support structure in the third direction comprises:
moving the mounting fixture of the second support structure in the third direction, over a first distance, to loosen the fit of the receptacle of the mounting fixture thereof about the post, prior to releasing the securing of the post within the receptacle; and
moving the mounting fixture of the second support structure further in the third direction, over a second distance, to tighten the fit of the receptacle of the mounting fixture of the first support structure about the post.

15. The method of claim 11, wherein the first direction is horizontal.

16. The method of claim 11, wherein the second and third directions are vertical.

17. A system useful for transferring a medical device between a first support structure and a second support structure, the system comprising an elongate transfer post, the post comprising:
a first terminal end adapted for removable attachment to the medical device;
a first tapered segment that tapers along a longitudinal axis of the post from a first diameter to a second diameter, the first diameter being greater than the second diameter and being located in closer proximity to the first terminal end than the second diameter, and the first tapered segment being configured such that an outer surface thereof wedges against an inner surface of a mounting receptacle of the first support structure, once the second diameter is moved axially into the mounting receptacle of the first support structure, through a radial opening thereof;
a second tapered segment that tapers along the longitudinal axis from a third diameter to a fourth diameter, the third diameter being greater than the fourth diameter and being located in closer proximity to the first terminal end than the fourth diameter, and the second tapered segment being configured such that an outer surface thereof wedges against an inner surface of a mounting receptacle of the second support structure, once the fourth diameter is moved axially into the mounting receptacle of the second support structure, through a radial opening thereof; and
a first transfer segment extending between the first and second tapered segments and having a diameter that is less than the first and third diameters, the first transfer segment being sized to move freely into and out from the mounting receptacle of the first support structure through an axial opening thereof.

18. The system of claim 17, wherein the post further comprises:
a second terminal end; and
a second transfer segment extending between the second tapered segment and the second terminal end and having a diameter that is less than the first and third diameters, the second transfer segment being sized to move freely into and out from the mounting receptacle of the second support structure through an axial opening thereof.

19. The system of claim 18, wherein the post further comprises a fastening mechanism located in proximity to the second terminal end, such that, when the outer surface of the second tapered segment wedges against the inner surface of the mounting receptacle of the second support structure, the fastening mechanism may be activated to prevent further axial movement of the second tapered segment with respect to the mounting receptacle of the second support structure.

20. The system of claim 19, wherein the fastening mechanism comprises a nut-type fastener and a set of mating threads.

21. The system of claim 17, wherein the post further comprises a third tapered segment that tapers along the longitudinal axis from a fifth diameter to a sixth diameter, the fifth diameter being smaller than the sixth diameter, and coinciding with the first terminal end of the post.

22. The system of claim 17, further comprising a mounting fixture adaptable for removable attachment to the first support structure, the mounting fixture forming the mounting receptacle of the first support structure, when attached thereto.

23. The system of claim 22, wherein the inner surface of the mounting receptacle of the first support structure tapers from a larger diameter at the radial opening thereof to a smaller diameter within the receptacle.

24. The system of claim 17, further comprising a mounting fixture adaptable for removable attachment to the second support structure, the mounting fixture forming the mounting receptacle of the second support structure, when attached thereto.

25. The system of claim 24, wherein the inner surface of the mounting receptacle of the second support structure tapers from a larger diameter at the radial opening thereof to a smaller diameter within the receptacle.

26. The system of claim 24, wherein:
the mounting receptacle of the second support structure includes an axial opening;
the post further comprises a second terminal end and a second transfer segment; and
the second transfer segment extends between the second tapered segment and the second terminal end and has a diameter that is less than the first and third diameters, the second transfer segment being sized to move freely into and out from the mounting receptacle of the second support structure through the axial opening thereof.

27. The system of claim 24, wherein the second support structure comprises a rail of a patient table.

28. The system of claim 17, further comprising:
a first mounting fixture adaptable for removable attachment to the first support structure, the first mounting fixture forming the mounting receptacle of the first support structure, when attached thereto; and
a second mounting fixture adaptable for removable attachment to the second support structure, the second mounting fixture forming the mounting receptacle of the second support structure, when attached thereto.

29. A medical system comprising a medical device and an elongate transfer post attached to the medical device and extending therefrom, the elongate transfer post comprising:
a first tapered segment that tapers along the longitudinal axis from a first diameter to a second diameter, the first diameter being greater than the second diameter and being located in closer proximity to the medical device than the second diameter, and the first tapered segment being configured such that an outer surface thereof wedges against an inner surface of a mounting receptacle of a first structure for supporting the medical device, once the second diameter is moved axially into the mounting receptacle of the first structure, through a radial opening thereof;
a second tapered segment that tapers along the longitudinal axis from a third diameter to a fourth diameter, the third diameter being greater than the fourth diameter and being located in closer proximity to the first tapered segment than the fourth diameter, and the second tapered segment being configured such that an outer surface thereof wedges against an inner surface of a mounting receptacle of a second structure for supporting the medical device, once the fourth diameter is moved axially into the mounting receptacle of the second structure, through a radial opening thereof; and
a first transfer segment extending between the first and second tapered segments and having a diameter that is less than the first and third diameters, the first transfer segment being sized to move freely into and out from the mounting receptacle of the first structure through an axial opening thereof for transfer of the medical device between support of the first and second structures.

30. The medical system of claim 29, wherein the elongate transfer post further comprises:
a terminal end; and
a second transfer segment extending between the second tapered segment and the terminal end and having a diameter that is less than the first and third diameters, the second transfer segment being sized to move freely into and out from the mounting receptacle of the second structure through an axial opening thereof for transfer of the medical device between support of the first and second structures.

31. The medical system of claim 30, wherein the elongate transfer post further comprises a fastening mechanism located in proximity to the terminal end, such that, when the outer surface of the second tapered segment wedges against the inner surface of the mounting receptacle of the second structure, the fastening mechanism may be activated to prevent further axial movement of the second tapered segment with respect to the mounting receptacle of the second structure.

32. The medical system of claim 31, wherein the fastening mechanism comprises a nut-type fastener and a set of mating threads.

33. The medical system of claim 29, further comprising a mounting fixture adaptable for removable attachment to the first structure, the mounting fixture forming the mounting receptacle of the first structure, when attached thereto.

34. The medical system of claim 33, wherein the mounting receptacle of the first structure tapers from a larger diameter at the radial opening thereof to a smaller diameter within the receptacle.

35. The medical system of claim 29, further comprising a mounting fixture adaptable for removable attachment to the second structure, the mounting fixture forming the mounting receptacle of the second structure, when attached thereto.

36. The medical system of claim 35, wherein the mounting receptacle of the second structure tapers from a larger diameter at the radial opening thereof to a smaller diameter within the receptacle.

37. The medical system of claim 35, wherein:
the mounting receptacle of the second structure includes an axial opening;
the post further comprises a terminal end and a second transfer segment; and
the second transfer segment extends between the second tapered segment and the terminal end and has a diameter that is less than the first and third diameters, the second transfer segment being sized to move freely into and out from the mounting receptacle of the second structure through the axial opening thereof for transfer of the medical device between support of the first and second structures.

38. The medical system of claim 35, wherein the second structure comprises a rail of a patient table.

39. The medical system of claim 29, further comprising:
a first mounting fixture adaptable for removable attachment to the first structure, the first mounting fixture forming the mounting receptacle of the first structure, when attached thereto; and
a second mounting fixture adaptable for removable attachment to the second structure, the second mounting fixture forming the mounting receptacle of the second structure, when attached thereto.

40. The medical system of claim 29, further comprising a cart to transport the medical device, the cart including the first structure for supporting the medical device.
